(19) United States
(12) Patent Application Publication
(10) Pub. No.: US 2003/0048895 A1
(43) Pub. Date: Mar. 13, 2003

(54) Wall phone adapter with removable filter modular units

(76) Inventors: Frederick J. Kiko, Carlsbad, CA (US); Randy Grifford, Carlsbad, CA (US)

Correspondence Address: DAVIS CHIN, 16061 S. 94TH AVENUE, ORLAND HILLS, IL, 60477-4623, US

(21) Appl. No.: 09/948,438

(22) Filed: Sep. 10, 2001

(51) Int. Cl. H04M 1/00; H04M 9/00

(52) U.S. Cl. 379/390.02; 379/428.01

(57) ABSTRACT

A wall phone adapter is provided which accommodates a variety of removable filter modular units for interconnection between incoming telephone lines connected to a wall mounting plate and subscriber's network termination equipment. The wall phone adapter includes a cover housing for receiving snappingly a removable filter modular unit. The removable filter modular unit has an impedance blocking filter circuit mounted thereon. The wall phone adapter further includes upper and lower slidable latches so as to facilitate connections to studs formed on the wall mounting plate which has either a standard studs-spacing or a closer studs-spacing.

### BACKGROUND OF THE INVENTION

This invention relates generally to impedance blocking filter circuits used in telecommunication systems. More particularly, it relates to a wall phone adapter of a unique construction which is adapted to accommodate a variety of removable filter modular units for interfacing between incoming telephone lines connected to a wall telephone mounting plate and subscriber's or customer's network termination equipment.

In view of telephone technology of today, there are many telephone subscribers or customers that have a personal computer with a modem located on their premises. At times, the computer user desires to receive DSL (an acronym for Digital Subscriber Line) signals from the Internet over the same telephone lines via the modem which is connected to an Internet Service Provider (ISP). In order to increase the speed of downloading of information from the Internet, a DSL network interface is typically purchased and installed between the incoming telephone lines and the user's computer. However, since one or more telephone subscriber's network termination equipment such as telephone sets (including cordless types), answering machines, facsimile (FAX) machines, 56 kb/s and lower rate modems, automatic dialers, and recorder connectors are also connected to the same incoming telephone lines via internal house wiring, DSL interference problems may be caused by the network termination equipment which can significantly decrease data rates and/or can create attenuation loss, radiate noise and generate cross-talk.

Accordingly, it has now been necessary to install some type of impedance blocking filter circuit on all of the subscriber's network termination equipment including wall phones so as to eliminate any erratic changes in the input impedances thereof. Unfortunately, the phone jacks for the wall phones are usually located in small, tight spaces such as in kitchens, hallways, garages and the like where it is inconvenient to place a table top phone. Generally, a wall telephone mounting plate is used for mounting the wall phone and includes a central communication jack with a pair of vertically spaced-apart mounting posts. In order to install the wall phone, a plug in the back of the phone is initially aligned with the central wall jack in the mounting plate and is then pushed into the jack so as to make a connection. At the same time, the pair of mounting posts are received in holes in the back of the wall phone, and the phone is thereafter pulled downwardly so as to securely hold the same in place.

There are known in the prior art of filter adapters which have been designed so as to interface between the wall telephone mounting plate and the subscriber's equipment. However, they have all suffered from one or more disadvantages such as being large, bulky, expensive and/or difficulties in installation. Further, other prior art designs have the drawbacks of being unable to fit in applications where the wall phone jacks are too close to a counter or cabinet and/or being too costly for manufacturing due to all of the wiring required for the filter components.

Moreover, in some applications it is desirable to connect a number of impedance blocking filter circuits within the wall phone adapter so as to accommodate multiple telephone lines. With the existing filter adapters, it is difficult to achieve from a manufacturing standpoint interchangeability of single, dual or triple impedance blocking filter circuits without using totally different filter adapter housings for each application. Thus, the use of a plurality of different filter adapter housings suffer from certain economic drawbacks such as increased manufacturing and inventory costs. Further, the existing filter adapter designs are typically not compatible with the shorter studs-spacing on the wall mounting plate. Also, in some installations the customers may not have any wall phone mounting plates located on their premises and have only wall jacks used with desk phones.

In view of all of the aforementioned problems that have been encountered heretofore in the prior art filter adapters, it would be desirable to provide a wall phone adapter housing for accommodating a variety of removable filter modular units from a manufacturing standpoint. Moreover, the filter modular unit may be removed from the wall phone adapter and then used as separate in-line filter where the wall phone adapter is not required. It would also be expedient that the wall phone adapter housing be compatible for use with not only the standard wall stud-spacings on a wall mounting plate, but also the closer stud-spacing of a secondary standard.

### SUMMARY OF THE INVENTION

Accordingly, it is a general object of the present invention to provide a wall phone adapter housing of a unique construction which is relatively simple and economical to manufacture and assemble.

It is an object of the present invention to provide a wall phone adapter for accommodating a variety of removable filter modular units for interfacing between incoming telephone lines connected to a wall telephone mounting plate and subscriber's or customer's network termination equipment.

It is another object of the present invention to provide a wall phone adapter which includes a cover housing for receiving a removable filter modular unit having an impedance blocking filter circuit mounted thereon.

It is still another object of the present invention to provide a wall phone adapter which includes slidable latch means for facilitating use with both the standard wall studs-spacing on a wall mounting plate and the closer studs-spacing of a secondary standard.

In accordance with a preferred embodiment of the present invention, there is provided a wall phone adapter for interconnection between a wall jack mounted on a wall mounting plate and a wall telephone set. The wall phone adapter includes a cover housing having a front wall member, a top wall member, a bottom wall member and confronting side wall members. The top wall member, bottom wall member and confronting side wall members are formed integrally with the front wall member and extend rearwardly therefrom so as to define a cavity for receiving snappingly a removable filter modular unit. The removable filter modular unit has an impedance blocking filter circuit mounted thereon.

A filtered modular adapter telephone jack is mounted in a central portion of the front wall member of the cover housing for receiving a first modular plug connected to a telephone set. A first filter modular line jack is formed on one side of the removable filter modular unit. A second filter modular phone jack is formed on another side of the removable filter modular unit for receiving a second modular plug connected to an answer machine or fax machine. A third filter DSL pass-through jack is formed also on the other side of the removable filter modular unit for receiving a third modular plug connected to DSL or HPN equipment devices. A movable line cord is provided with a modular phone plug connected to its one end for insertion into a line phone jack on a wall phone mounting plate and a modular filter input plug connected to its other end for insertion into the first filter modular line jack. Electrical wiring connections are operatively coupled between the filter input plug and the adapter telephone jack.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is a front plan view of a wall phone adapter, constructed in accordance with the principles of the present invention;

FIG. 2 is a front, perspective view of the wall phone adapter of FIG. 1;

FIG. 3 is a rear, perspective view of the wall phone adapter of FIG. 1;

FIG. 4 is a side view of the wall phone adapter, taken along the lines 4-4 of FIG. 1;

FIG. 5 is a rear plan view of the wall phone adapter of FIG. 1;

FIG. 6 is an enlarged view of the encircled area A of FIG. 5, showing the upper slidable latch being detached;

FIG. 7 is an enlarged view of the encircled area B of FIG. 5, showing the lower slidable latch being detached;

FIG. 8 is a rear plan view, similar to FIG. 5, but with a single filter modular unit installed therein;

FIG. 9 is a side view, similar to FIG. 4, taken along the lines 9-9 of FIG. 8 and illustrating the phone and DSL/HPN output jacks of the filter modular unit;

FIG. 10 is an exploded, side view of the filter modular unit of FIG. 8;

FIG. 11 is a rear plan view of a second embodiment of a wall phone adapter, similar to FIG. 8, illustrating use with a dual filter modular unit installed;

FIG. 12 is an exploded, side view of the filter modular unit of FIG. 11;

FIG. 13 is a rear plan view of a third embodiment of a wall phone adapter, similar to FIG. 8, illustrating use with a triple filter modular unit installed;

FIG. 14 is a side view, similar to FIG. 4, taken along the lines 14-14 of FIG. 13;

FIG. 15 is a schematic diagram showing the three input/output jacks and their connections for the single filter modular unit of FIG. 8; and

FIG. 16 is a schematic diagram showing the three input/output jacks and their connections for the dual filter modular unit of FIG. 11.

### DESCRIPTION OF THE PREFERRED EMBODIMENTS

As was previously pointed out, since DSL signals from the Internet are connected to the same incoming lines which are also connected to the telephone subscriber's network termination equipment (e.g., telephone sets) there has arisen the need of installing impedance blocking filters on all of the subscriber's network termination equipment including wall phones so as to eliminate any erratic changes in the input impedances thereof. The wall phones are typically mounted on a wall mounting plate having a pair of standoff studs (mounting posts) that are spaced apart a standard distance and a central jack. While there exists wall phone adapters for housing such impedance blocking filter circuits therein, they are unable to accommodate a variety of different impedance blocking filter circuits. Therefore, a number of different wall phone adapter housings had to be manufactured and stocked, thereby increasing production and labor costs. In addition, these existing wall phone adapter designs were not suitable for mounting onto a wall mounting plate having shorter studs-spacing. Thus, the purpose of the present invention is to provide a wall phone adapter which houses a filter modular unit that can be removed and used as a separate in-line filter when the wall phone adapter is not required. The wall phone adapter also may be used to accommodate from a manufacturing standpoint a variety of removable filter modular units for different applications. Further, the wall phone adapter of the instant invention is compatible with both the standard wall studs-spacing as well as the shorter wall studs-spacing.

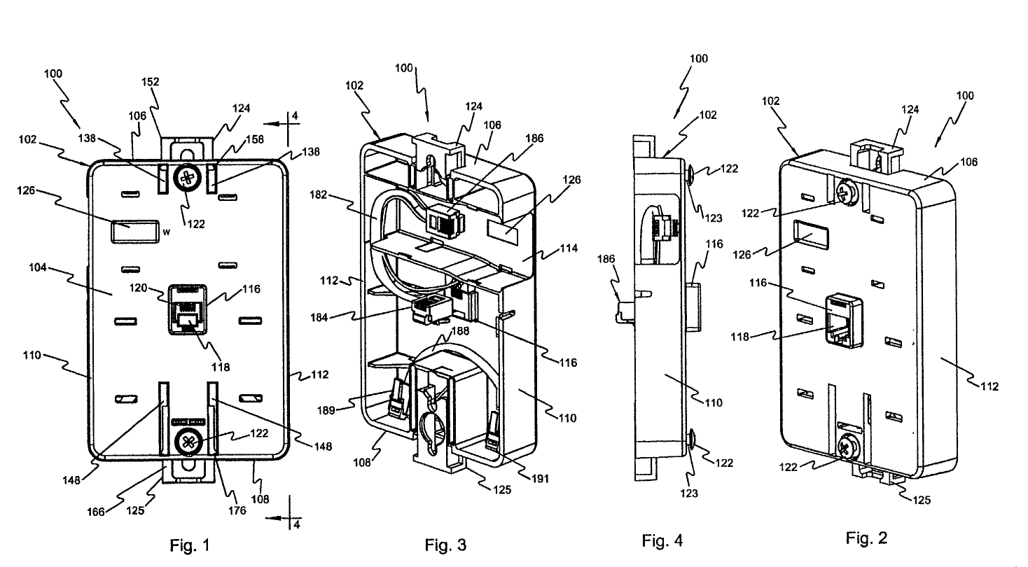

Referring now to the various views of the drawings, there is shown in FIGS. 1 through 4 a wall phone adapter 100, constructed in accordance with the principles of the present invention, which is formed of a unique configuration, so as to receive snappingly a variety of removable filter modular units. The wall phone adapter 100 is adapted for interfacing between a wall telephone mounting plate (not shown) and a conventional wall telephone set (also not shown). The removable filter modular unit is used to house an impedance blocking filter circuit which serves to isolate all voice band equipment devices such as telephone sets (including cordless types), answering machines, facsimile (Fax) machines, 56 kb/s and lower rate modems, automatic dialers, and recorder connectors located at a subscriber's or customer's premises from the high-speed DSL (Digital Subscriber Line) and HPN (Home Phone Network) signals (data streams).

The wall phone adapter is molded from a suitable plastic material such as ABS plastic and the like and is comprised of a front or cover housing 102 which includes a front wall member 104, a top wall member 106, a bottom wall member 108, and confronting sidewall members 110, 112. All of the top wall member, bottom wall member, and confronting sidewall members 106-112 are formed integrally with the front wall member 104 and extend rearwardly therefrom so as to define a cavity 114 for receiving snappingly one of a plurality of the removable filter modular units. The front wall member 104 has an aperture formed in a central location through which a filtered RJ-11 wall phone jack 116 extends integrally therefrom. The wall phone jack 116 has the footprint of a conventional communication jack which includes a plug-receiving aperture 118 and spring-type conductor contacts 120.

There are disposed vertically on opposite sides of the phone jack 116 and adjacent to the top and bottom edges of the front wall member 104 a pair of standoff mounting posts or studs 122 which are spaced apart a standard distance for mounting the wall telephone set. Each of the studs 122 includes a shank portion 123 which functions as a support when the telephone set is installed thereon with a modular plug on the wall telephone set being inserted into the aperture 118 and connected in the phone jack 116. An upper slidable latch 124 is insertable into the top wall member 106 of the cover housing 102, and a lower slidable latch 125 is insertable into the bottom wall member 108 of the cover housing. The front wall member 104 also includes a small window opening 126 for allowing visual indication of the part or model number printed on the removable modular filter unit when it is installed in the cavity 114.

As can best be seen from FIGS. 5 through 7, there is provided a rectangularly-shaped latch-receiving chamber 127 which is formed in the intermediate area of the top wall member 106 for receiving the upper slidable latch 124. Similarly, there is provided a rectangularly-shaped latch-receiving chamber 128 which is formed in the intermediate area of the bottom wall member 108 for receiving the lower slidable latch 125. The latch-receiving chamber 127 is defined by opposed vertical wall members 130, 132 and a horizontal wall member 134 all integrally joined together. The vertical wall members 130, 132 are joined integrally to portions of the top wall member 106. Each of the vertical wall members is provided with a stepped portion 136. Each of the vertical wall members also forms with a portion of the latch-receiving chamber 127 a vertical channel 138 in which the upper slidable latch 124 reciprocates. The latch-receiving chamber 128 is defined by opposed vertical wall members 140, 142 and a horizontal wall member 144 all integrally joined together. The vertical wall members 140 and 142 are joined integrally to portions of the bottom wall member 108. Each of the vertical wall members is also provided with a stepped portion 146. Each of the vertical wall members also forms with a portion of the latch-receiving chamber 128 a corresponding vertical channel 148 in which the lower slidable latch reciprocates.

In FIG. 6, the upper slidable latch 124 includes a raised central portion 150 and slides 152 connected integrally to each side of the central section 150. The central section is formed with an arcuate-shaped slot 154 with locking bumps 156 disposed on each end thereof. At the lower ends of each of the slides 152, there are provided latching hooks 158. As the slides 152 of the upper slidable latch 124 is inserted initially into the corresponding channels 138 of the latch-receiving chamber 127, the latching hooks 158 will lockingly engage with the interior surface of the top wall member 106. As the latch 124 continues to slide downwardly, the slot 154 will engage with the existing upper stud 160 and will hold in place the housing adapter 100 due to the locking bumps 156. The stepped portions 136 act as stop members and will engage with the extensions 162 of the latch 124 so as limit its further movement. It should be noted that the upper slidable latch 124 which has been shown detached from the top wall member 106 is reversed.

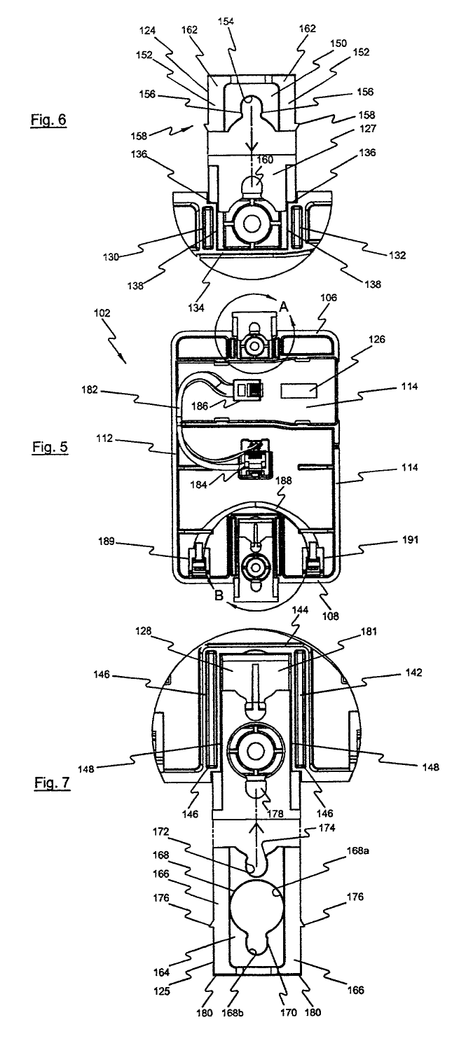

In FIG. 7, the lower slidable latch 125 includes a raised central portion 164 and slides 166 connected integrally to each side of the central section 164. The central section is formed with a keyhole slot 168 having a larger opening 168a and a first arcuate-shaped opening 168b. The first arcuate-shaped opening 168b is provided with locking bumps 170 disposed on each end thereof. The central portion 164 is also formed with a second arcuate-shaped slot 172 with locking bumps 174 disposed on each end thereof. At the intermediate areas of each of the slides 166, there are provided latching hooks 176. As the slides 166 of the lower slidable latch 125 is inserted initially into the corresponding channels 148 of the latch-receiving chamber 128, the latching hooks 176 will lockingly engage with the interior surface of the bottom wall member 108. The larger opening 168a is aligned with the head of the lower existing wall plate stud 178 of a standard stud-spacing. As the latch continues to slide upwardly, the opening 168b will engage with the lower existing stud 178 and will hold in place the housing adapter 102 due to the locking bumps 170. The stepped portion 146 acts as a stop member and will engage with extensions 180 of the lower latch 125 so as to limit its further movement. It should be noted that the lower slidable latch 125 which has been shown detached from the bottom wall member 108 is reversed.

In order to accommodate the shorter studs-spacing of a secondary standard, the area 181 of the latch-receiving chamber is aligned with the head (not shown) of the lower existing stud of a shorter or closer studs-spacing. Then, as the lower latch continues to slide upwardly, the arcuate slot 172 will be used to engage with the lower existing stud of the shorter spacing and will hold in place the housing adapter 102 due to the locking bumps 174.

Referring now back to FIGS. 3 and 5, there is shown a moveable line plug/cord 182 having a RJ-11 modular phone plug 184 connected to its one end for insertion into the wall phone wall jack located on the customer's wall phone mounting plate and a RJ-11 modular filter input plug 186 connected to its other end which is insertable into a line jack of the removable filter modular unit. A short pigtail cord 188 is arranged and stored near the interior of the bottom wall member 108.

In FIG. 8, there is illustrated a rear plan view of the wall phone adapter 102, which is similar to FIG. 5, but with a single removable filter modular unit 190 installed therein in accordance with a first embodiment of the present invention. As will be noted, the modular filter input plug 186 is plugged into a line jack 192 positioned on the left side of the modular unit 190. Since the modular wall phone plug 184 is left unsecured, it can be manipulated and plugged into the existing wall phone wall jack of the wall mounting plate. Thus, the modular filter input plug 184 is movable so as to accommodate slight variations in the vertical location of the existing wall phone jack due to the shorter studs-spacing. After the modular filter input plug 186 is installed in the line jack 192, the filter modular unit 190 is snap fitted into the cavity 114 which has been suitably dimensioned.

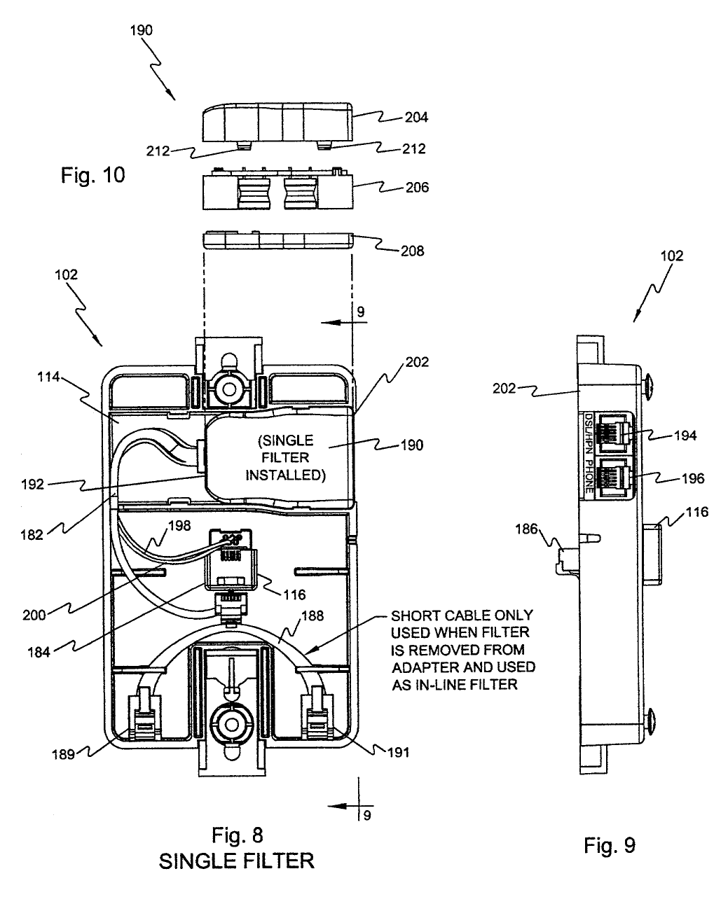

As can be seen from FIG. 9, the filter modular unit 190 includes a second filter modular phone jack 194 positioned on its right side for connection to the customer's termination equipment such as a telephone set, answering machine or facsimile (Fax) machine. The filter modular unit 190 also includes a third filter DSL/HPN pass-through jack 196 positioned on the right side of FIG. 8 which is used for the DSL or HPN equipment devices. This output jack 196 is unfiltered on the line connected to the DSL or HPN connection. It will be noted that there are provided electrical wiring connections defined by two separate wires 198, 200 each having its one end connected to the filter input plug 186 for connection to the output side of the modular filter unit 190 and having its other ends joined to the wall phone jack 116 of the wall phone adapter 102. The sidewall member 112 is formed with a U-shaped slot 202 through which access to the output jacks 194, 196 are obtainable.

If the modular filter unit 190 is not being used, it can simple be removed from the adapter housing 102. Then, the removed modular filter unit 190 may be used as a stand-alone in-line filter by utilizing the short pigtail cord 188. The short pigtail cord 188 has a modular plug 189 connected to its one end for plugging into the line jack 192 of the filter modular unit 190 and has its other end connected to a modular plug 191 for plugging into a wall phone jack connected to the incoming telephone lines.

In FIG. 10, there is depicted an exploded side view of the removable modular filter unit 190 of FIG. 8 which will now be explained. The modular filter unit 190 is comprised of a top cover member 204, a PCB printed circuit board assembly 206, and a bottom base member 208. The PCB assembly 206 is used to mount the electrical components of the impedance blocking filter circuit 210 contained within the modular filter unit 190 depicted in the schematic diagram of FIG. 15. The schematic diagram of FIG. 15 shows the three input/output filter jacks of the single filter modular unit 190 and their electrical connections to the impedance blocking filter circuit 210.

The top cover member 204 is provided with a plurality (two) of retaining posts 212. The retaining posts extend downwardly and are adapted to mate with retaining holes formed in the bottom member 208. In assembly, the PCB assembly 206 is placed into the bottom member 208. Then, the cover member 204 is placed over the PCB assembly 206 so that the retaining posts 212 are received snappingly into the retaining holes in the bottom member 208, thereby sandwiching the PCB assembly 206 therebetween. The cover member 204 and the bottom member 208 are secured together by any conventional means of friction such as ultrasonic welding or the like so as to provide the single filter modular unit 190 in its fully assembled condition, as depicted in FIG. 8.

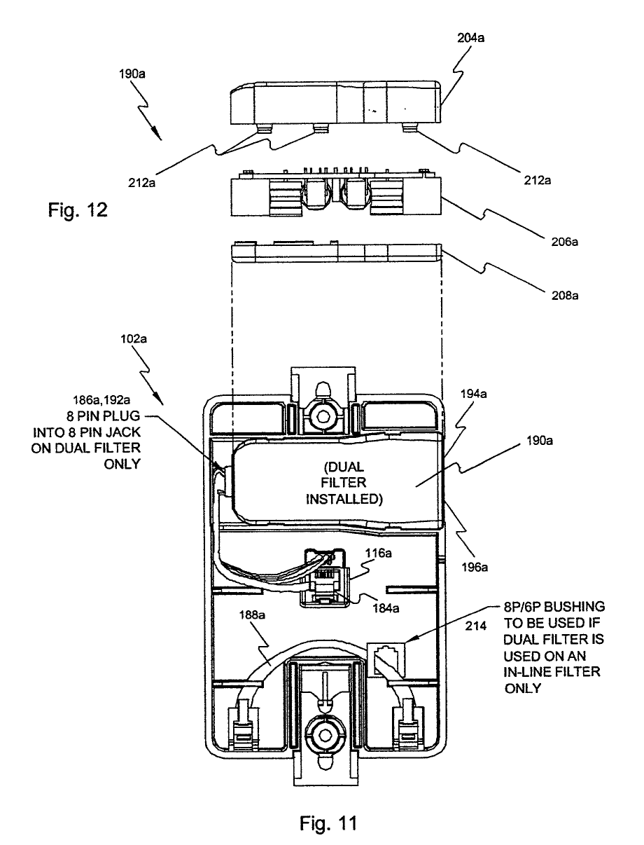

In FIG. 11, there is illustrated a rear plan view of a wall phone adapter 102a which is substantially identical to FIG. 8, but is used with a dual filter modular unit 190a installed therein in accordance with a second embodiment of the present invention. Thus, only the differences will now be described. The line jack 192a is an eight-conductor modular jack instead of the four-conductor modular jack used in FIG. 8. Further, the filter phone modular jack 194a and the DSL pass-through jack 196a are four-conductor modular jacks instead of the two-conductor modular jacks used in FIG. 8. In addition, the modular filter input plug 186a is an eight-conductor modular plug instead of a four-conductor modular plug used in FIG. 8. The modular wall phone plug 184a is a four-conductor modular plug instead of the two-conductor modular plug of FIG. 8. Further, wall phone jack 116a is a four-conductor modular jack instead of the two-conductor modular jack of FIG. 8. An 8P/6P bushing 214 is provided for use with the pigtail cord 188a which is plugged into the line jack 192a of the dual filter modular unit 190a when it is utilized as an inline filter.

In FIG. 12, there is depicted an exploded side view of the dual filter modular unit 190a of FIG. 11 which will now be explained. The filter modular unit 190a is comprised of a top cover member 204a, a PCB assembly 206a, and a bottom base member 208a. The PCB assembly 206a is used to mount the electrical components of the impedance blocking filter circuits 210a contained within the dual filter modular unit 190a depicted in the schematic diagram of FIG. 16. The schematic diagram of FIG. 16 shows the three input/output jacks of the dual filter modular unit 190a and their electrical connections to the impedance blocking filter circuits 210a. A detailed schematic circuit diagram of the dual filter modular units 190a is illustrated in FIG. 17 of co-pending application Ser. No. 09/929,775 and filed on Aug. 15, 2001 and entitled “COMPACT WALL PHONE FILTER HOUSING UNIT,” assigned to the same assignee as the present invention, which is hereby incorporated by reference in its entirety.

It should be understood that other impedance filter circuits may be alternatively mounted on the PCB assembly 206a. Such alternate blocking filter circuits are illustrated and described in U.S. Pat. No. 6,188,750 issued on Feb. 13, 2001, assigned to the same assignee as the present invention, which is likewise incorporated herein by reference.

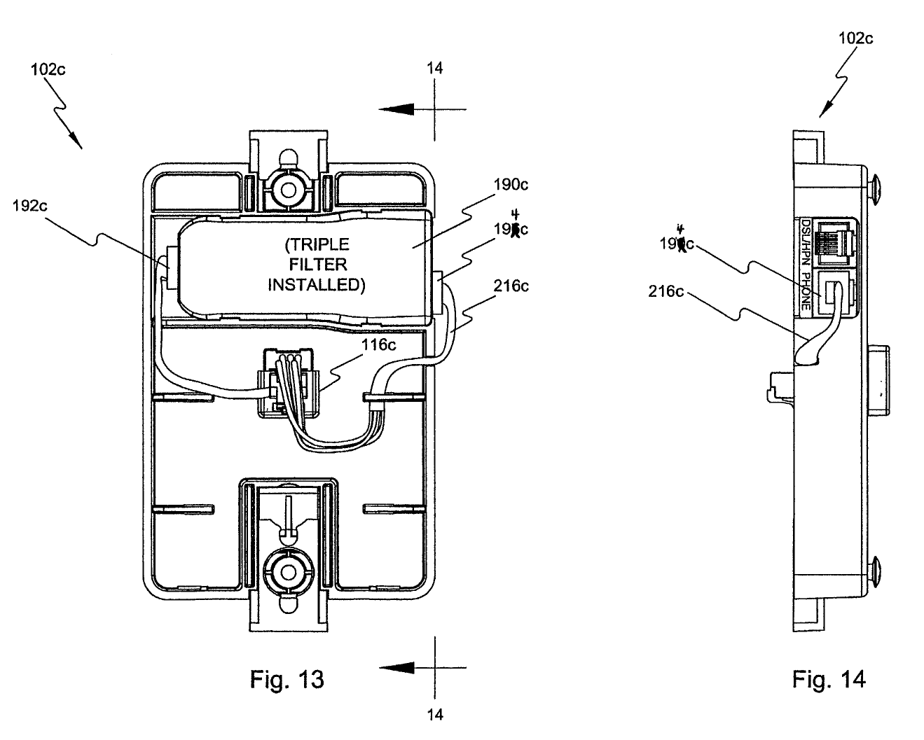

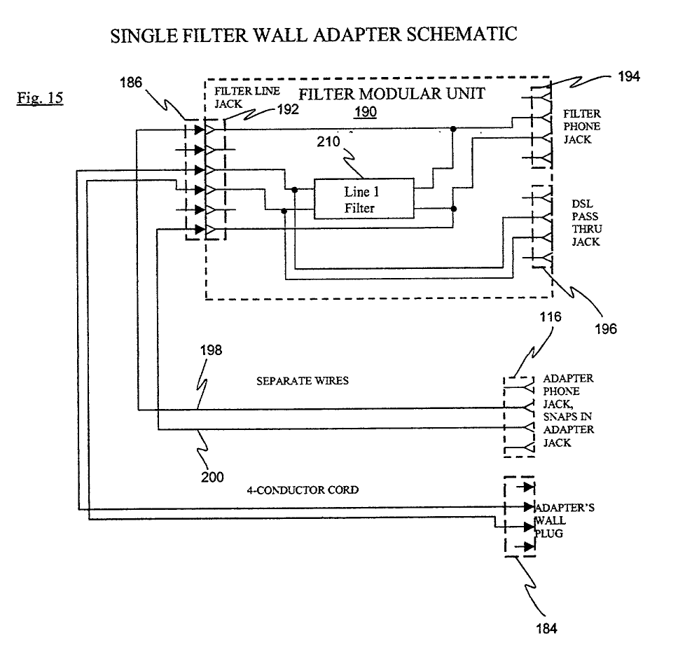

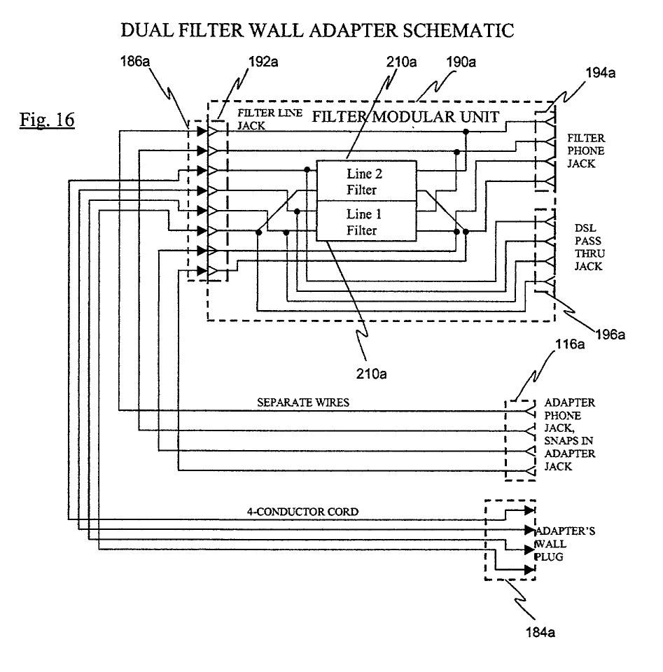

In FIG. 13, there is illustrated a rear plan view of a wall filter adapter 102c which is substantially identical to FIG. 11, but is used with a triple filter modular unit 190c installed therein in accordance with a third embodiment of the present invention. Thus, only the differences will now be described. As can be seen, the output from the filter phone modular jack 194c is connected directly to the adapter phone jack 116c rather than being connected from the line jack 192c since this would require a 12-conductor modular jack which is not practical. FIG. 14 is a side elevational view, similar to FIG. 4, taken along the lines 14-14 of FIG. 13. An electrical wiring connection 216c is coupled between the output jack 194c and the adapter wall phone jack 116c.

From the foregoing detailed description, it can thus be seen that the present invention provides a wall phone adapter for accommodating a variety of removable filter modular units for interfacing between incoming telephone lines connected to a wall telephone mounting plate and subscriber's or customer's network termination equipment. The wall phone adapter includes a cover housing which is formed with a cavity. The cavity is used to receive snappingly a removable filter modular unit having an impedance blocking filter circuit mounted therein. The wall phone adapter includes upper and lower slidable latches so as to facilitate connection to both studs with a standard spacing and studs with a closer spacing.

While there has been illustrated and described what are at present considered to be preferred embodiments of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiments disclosed as the best modes contemplated for carrying out the invention, but that the invention will include all embodiments falling within the scope of the appended claims.

1. A wall phone adapter for interconnection between a wall jack mounted on a wall mounting plate and a wall telephone set, comprising:
a cover housing formed of a front wall member, a top wall member, a bottom wall member and confronting sidewall members;
said top wall member, said bottom wall member, and said confronting sidewall members being formed integrally with said front wall member and extending rearwardly therefrom so as to define a cavity for receiving snappingly a removable filter modular unit;
said removable filter modular unit having an impedance blocking filter circuit mounted therein;
a filtered modular adapter telephone jack mounted in a central portion of said front wall member of said cover housing for receiving a first modular plug connected to a telephone set;
a first filter modular line jack formed on one side of said removable filter modular unit;
a second filter modular phone jack formed on another side of said removable filter modular unit for receiving a second modular plug connected to an answering machine or Fax machine;
a third filter DSL pass-through jack formed also on said another side of said removable filter modular unit for receiving a third modular plug connected to DSL or HPN equipment devices;
a movable line cord having a modular phone plug connected to its one end for insertion into a wall phone jack on a wall phone mounting plate and having a modular filter input plug connected to its other end for insertion into said first filter modular line jack; and
electrical wiring connections operatively coupled between said filter input plug and said adapter telephone jack.

2. A wall phone adapter as claimed in claim 1, further comprising a short pigtail cord being stored in said cover housing, said pigtail cord having a first end connected to a modular plug and having a second end connected to a modular plug.

3. A wall phone adapter as claimed in claim 2, wherein said modular filter unit is removed from said cavity and is usable as an in-line filter by connecting the modular plug on the first end of said pigtail cord into the line jack of said modular filter unit and connecting the modular plug on the second end of said pigtail cord into a wall phone jack connected to incoming telephone lines.

4. A wall phone adapter as claimed in claim 1, wherein said modular filter unit houses either single, dual or triple input impedance blocking filter circuits.

5. A wall phone adapter as claimed in claim 1, further comprising slidable latch means for engaging and locking with studs formed on the wall mounting plate, said slidable latch means being adapted to accommodate both studs with a standard spacing and studs with a closer spacing.

6. A wall phone adapter as claimed in claim 5, wherein said slidable latch means includes an upper slidable latch and a lower slidable latch, each being provided with latching hooks for locking engagement with said respective top and bottom wall members of said cover housing.

7. A wall phone adapter as claimed in claim 6, wherein said lower slidable latch is provided with a first arcuate-shaped slot with bumps for locking engagement with studs of the standard spacing and a second arcuate-shaped slot with bumps for locking engagement with the studs of the closer spacing.

8. A wall phone adapter as claimed in claim 1, wherein a small window opening is formed in the front wall member for allowing visual indication of model number printed on said filter modular unit.

9. A wall phone adapter as claimed in claim 1, wherein said filter modular unit is comprised of a top cover plate, a PCB assembly, and a bottom plate.

10. A wall phone adapter as claimed in claim 9, wherein said top plate is formed with a plurality of retaining posts which mate with retaining holes formed in said bottom plates so as to sandwich the PCB assembly therebetween.

11. A wall phone adapter for interconnection between a wall jack mounted on a wall mounting plate and a telephone set, comprising:
cover housing means;
removable filter modular means disposed within said cover housing means for mounting an impedance blocking filter circuit;
adapter telephone jack means for connection to a telephone set;
filter input means formed on said removable filter modular unit;
filter output means formed on said removable filter modular means for connection to an answering machine and DSL equipment;
movable line cord means for connection between a modular jack connected to incoming telephone line and said filter input means; and
electrical wiring connection means operatively coupled between said filter input means and said adapter telephone jack means.

12. A wall phone adapter as claimed in claim 11, wherein said filter modular means houses either single, dual or triple input impedance blocking filter circuits.

13. A wall phone adapter as claimed in claim 12, wherein a small window opening is formed in said cover housing means for allowing visual indication of model number printed on said filter modular means.

14. A wall phone adapter as claimed in claim 11, wherein said filter modular means is comprised of a top cover plate, a PCB assembly, and a bottom plate.

15. A wall phone adapter as claimed in claim 14, wherein said top plate is formed with a plurality of retaining posts which mate with retaining holes formed in said bottom plates so as to sandwich the PCB assembly therebetween.

16. A wall phone adapter for interconnection between a wall jack mounted on a wall mounting plate and a telephone set, comprising:
cover housing means;
removable filter modular means disposed within said cover housing means for mounting an impedance blocking filter circuit;
adapter telephone jack means for connection to a telephone set;
filter input means formed on said removable filter modular unit;
filter output means formed on said removable filter modular means for connection to an answering machine and DSL equipment;
movable line cord means for connection between a modular jack connected to incoming telephone line and said filter input means;
electrical wiring connection means operatively coupled between said filter input means and said adapter telephone jack means; and
slidable latch means for engaging and locking with studs formed on the wall mounting plate so as to accommodate both studs with a standard spacing and studs with a closer spacing.

17. A wall phone adapter as claimed in claim 16, wherein said slidable latch means includes an upper slidable latch and a lower slidable latch, each being provided with latching hooks for locking engagement with said cover housing means.

18. A wall phone adapter as claimed in claim 17, wherein said lower slidable latch is provided with a first arcuate-shaped slot with bumps for locking engagement with studs of the standard spacing and a second arcuate-shaped slot with bumps for locking engagement with the studs of the closer spacing.

19. A wall phone adapter as claimed in claim 16, wherein said filter modular means is comprised of a top cover plate, a PCB assembly, and a bottom plate.

20. A wall phone adapter as claimed in claim 19, wherein said top plate is formed with a plurality of retaining posts which mate with retaining holes formed in said bottom plates so as to sandwich the PCB assembly therebetween.
